(19) United States
(12) Patent Application Publication
(10) Pub. No.: US 2013/0133953 A1
(43) Pub. Date: May 30, 2013

(54) REVERSE CIRCULATION DRILLING SYSTEM, APPARATUS AND METHOD

(71) Applicants: Dennis BURCA, Calgary (CA); Constantin BURCA, Calgary (CA)

(72) Inventors: Dennis BURCA, Calgary (CA); Constantin BURCA, Calgary (CA)

(21) Appl. No.: 13/599,860

(22) Filed: Aug. 30, 2012

(30) Foreign Application Priority Data
Nov. 30, 2011 (CA) 2759711

(51) Int. Cl. E21B 17/18; B23P 11/00

(52) U.S. Cl. 175/320; 29/428

(57) ABSTRACT

In one embodiment, the present invention provides a reverse circulation drilling apparatus which comprises a concentric dual wall drill pipe, having a first threaded end, a second threaded end, an outer pipe and an inner pipe captured in a concentric arrangement within the outer pipe and defining an annulus therebetween. The inner pipe defines an inside passage, which is not in fluid communication with the annulus. A first means for directing an outer flow of fluid through the annulus is provide. A second means for directing an inner flow of fluid through the inside passage is also provided. The first means and the second means prevent fluid communication between the outer flow and the inner flow. The first threaded end and the second threaded end are each suitable to connect the reverse circulation drilling apparatus to another reverse circulation drilling apparatus.

### FIELD OF THE INVENTION

The present invention relates generally to a reverse circulation drilling system, apparatus and method for mineral exploration and production of oil, natural gas, coal bed methane and methane hydrates, for water well drilling, and the like. More particularly, the present invention relates to modified drill subs to ease assembly of the concentric two-string, or dual wall pipe, drill string that is used during reverse circulation drilling.

### BACKGROUND OF THE INVENTION

Conventional directional and horizontal drilling typically uses a plurality of connected, single-wall jointed drill pipes with a drill bit attached at one end. Drill pipe, drillpipe or drillstem comes in a variety of sizes, strengths, and weights but are typically 30 to 33 feet in length. Drill pipe is comprised of tubular steel conduit fitted with special threaded ends called tool joints. The drill pipe connects the rig surface equipment with the bottomhole assembly and the drill bit, to pump drilling fluid to the bit and to be able to raise, lower and rotate the bottomhole assembly and bit.

Their hollow feature allows drilling fluid to be pumped through them, down the hole, and back up the annulus. This drilling mud or drilling fluid is pumped through while rotating the string of drill pipe to drive the drill bit to drill a borehole. The drill cuttings and exhausted drilling fluid are then returned to the surface up the annulus between the drill string and the formation by using mud, fluids, gases or various combinations of each to create enough pressure to transport the cuttings out of the wellbore. Compressed air can also be used to drive a rotary drill bit or air hammer.

Drillpipes are a portion of the overall drill string, which is a combination of the drillpipes, the bottomhole assembly and any other tools used to make the drill bit turn at the bottom of the wellbore. Individual drill pipes are joined together via their tool joints, which are the threaded ends of individual drillpipe. Often the tool joints are enlarged, also known as upset, and are fabricated separately from the pipe body and welded onto the pipe at a manufacturing facility. The tool joints provide high-strength, high-pressure threaded connections that are sufficiently robust to survive the rigors of drilling and numerous cycles of tightening and loosening at threads. Tool joints are usually made of steel that has been heat treated to a higher strength than the steel of the tube body. The often large-diameter section of the tool joints or upset provides an area where pipe tongs can be safely used to grip the pipe and where the relatively small cuts caused by the pipe tongs do not significantly impair the strength or life of the joint of drillpipe.

However, such conventional drilling has disadvantages. For example, the hydrostatic head of the fluid column can often exceed the pressure of the formation being drilled. Therefore, the drilling mud or fluid can invade into the formation, causing significant damage to the formation, which ultimately results in loss of production. In addition, the drill cuttings themselves can cause damage to the formation as a result of the continued contact with the formation. In underbalanced drilling, drill cuttings may be left in the deviated and horizontal sections of the wellbore.

Air core drilling and reverse circulation drilling, wherein concentric drill pipes are provided, the air, drilling mud or drilling fluid is forced downhole through the annular area (between the inner pipe and outer pipe), while the drill cuttings and exhausted drilling fluid or return air are directed back up to surface inside the inner pipe are well known in the art. The main advantage of these drilling techniques is that the drilling fluid, air and/or drill cuttings are not pushed between the outside of the main drill string and the wellbore wall, thereby reducing or eliminating damage to the formation.

Assembly of such a multi-pipe, concentric drill string, from individual drill pipes into a working reverse circulation drill string, is traditionally done by personnel, such as a driller, at the rig site. Typically, the driller assembles the inner and outer components together in a concentric arrangement, i.e. by attaching next inner tube to previous inner tube and attaching next outer casing or drill pipe to the previous casing or drill pipe, in a serial or sequential manner. Appropriate sealing members (such as orings) are added as during the assembly process. However, this is labour intensive and reduces overall drilling productivity.

Therefore, what is needed is a more efficient system, apparatus and method of reverse circulation drilling, that reduces the amount of labour required at the rig site.

### SUMMARY OF THE INVENTION

The present invention provides improvements to reverse circulation drilling systems, apparatuses and methods.

In one embodiment, the present invention provides a reverse circulation drilling apparatus which comprises a concentric dual wall drill pipe and a first and second drill sub. The concentric dual wall drill pipe has a first end, a second end, an outer pipe and an inner pipe positionable within the outer pipe and defining an annulus therebetween. The inner pipe also defines a central inside passage. The inside passage is not in fluid communication with the annulus.

The first drill sub is attached to the first end and has an internal through passage and at least one annular passage. The internal through passage is not in fluid communication with the annular passage. The second drill sub is attached to the second end and likewise has an internal through passage and at least one annular passage. The internal through passage of the second drill sub is likewise not in fluid communication with the annular passage. However, the annular passages of the first and second drill subs are in fluid communication with the annulus and the internal through passages of the first and second drill subs are in fluid communication with the central inside passage of the inner pipe.

In another embodiment, the present invention provides a reverse circulation drilling apparatus which comprises a concentric dual wall drill pipe, having a first threaded end, a second threaded end, an outer pipe and an inner pipe captured in a concentric arrangement within the outer pipe and defining an annulus therebetween. The inner pipe defines an inside passage, which is not in fluid communication with the annulus. A first means for directing an outer flow of fluid through the annulus is provide. A second means for directing an inner flow of fluid through the inside passage is also provided. The first means and the second means prevent fluid communication between the outer flow and the inner flow. The first threaded end and the second threaded end are each suitable to connect the reverse circulation drilling apparatus to another reverse circulation drilling apparatus.

Additional embodiments of the invention are also provided.

### BRIEF DESCRIPTION OF THE DRAWINGS

Embodiments of the invention will now be described, by way of example only, with reference to the accompanying drawings, wherein:

FIG. 1a is side perspective view of one embodiment of the invention, showing a concentric dual wall drill pipe with a drill sub connected to either end;

FIG. 1b is a side perspective view of the embodiment of FIG. 1a, showing the two drill subs in a sectioned view taken along line A-A of FIG. 1a;

FIG. 1c is a side perspective view of the embodiment of FIG. 1a, without the two drill subs, and showing inner pipe concentrically mounted within the outer pipe;

FIG. 1d is a side perspective view of the embodiment of FIG. 1a, showing one of the two drill subs at the pin end, and showing inner pipe concentrically mounted within the outer pipe exiting partially out at the box end;

FIG. 1e is a side perspective view of the embodiment of FIG. 1a, showing two concentric dual wall drill pipes connected together;

FIG. 1f is a side perspective view of the embodiment of FIG. 1e, showing the drill subs in a sectioned view along line B-B of FIG. 1e;

FIG. 1g is a side perspective view of the embodiment of FIG. 1a, showing two concentric dual wall drill pipes connected together and having the connections reinforced with groove welds;

FIG. 1h is an enlarged view of the circled area F in FIG. 1f;

FIGS. 2a-2f are various views of a preferred embodiment of a box-end drill sub, with FIGS. 2b, 2d and 2e being sectioned views taken along line C-C of FIG. 2a;

FIGS. 3a-3e are various views of a preferred embodiment of a pin-end drill sub, with FIGS. 3b, 3d and 3e being sectioned views taken along line D-D of FIG. 3a;

FIGS. 4a-4f are various views of a preferred embodiment of the box-end drill sub shown threadably connected to the pin-end drill sub, with FIGS. 4e and 4f being sectioned views; and

FIG. 5 is a perspective view of the inner pipe of the embodiment of FIG. 1a;

FIG. 6 is an side perspective view of another embodiment of the invention, wherein the outer wall portions of the first and second drill subs comprise a thickened conduit wall than the embodiment of FIG. 1a;

FIGS. 7a-7d are side perspective views of the embodiment of FIG. 1a, illustrating different configurations of box-end and pin-end drill subs; and

FIG. 8a-8c are sectioned views of another embodiment of a pin-end drill sub, a box-end drill sub, and a connected pin-end and box-end drill sub respectively.

### DETAILED DESCRIPTION OF THE PREFERRED EMBODIMENTS

The following description is of a preferred embodiment by way of example only and without limitation to the combination of features necessary for carrying the invention into effect. Reference is to be had to the Figures in which identical reference numbers identify similar components. The drawing figures are not necessarily to scale and certain features are shown in schematic or diagrammatic form in the interest of clarity and conciseness.

Referring now in detail to the accompanying drawings, there is illustrated an exemplary embodiment of apparatus, method and system according to the present invention, the system generally referred to by the numeral 10.

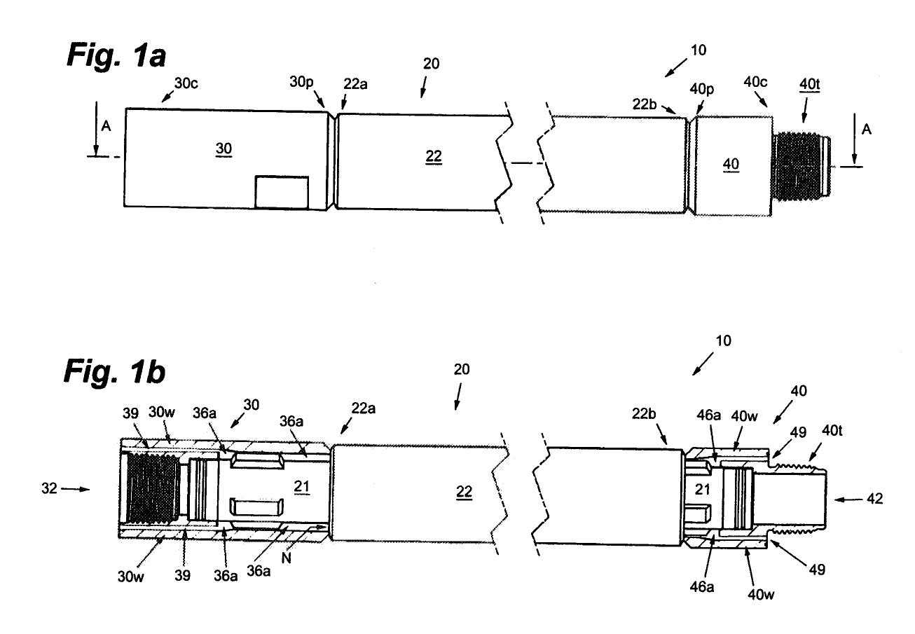

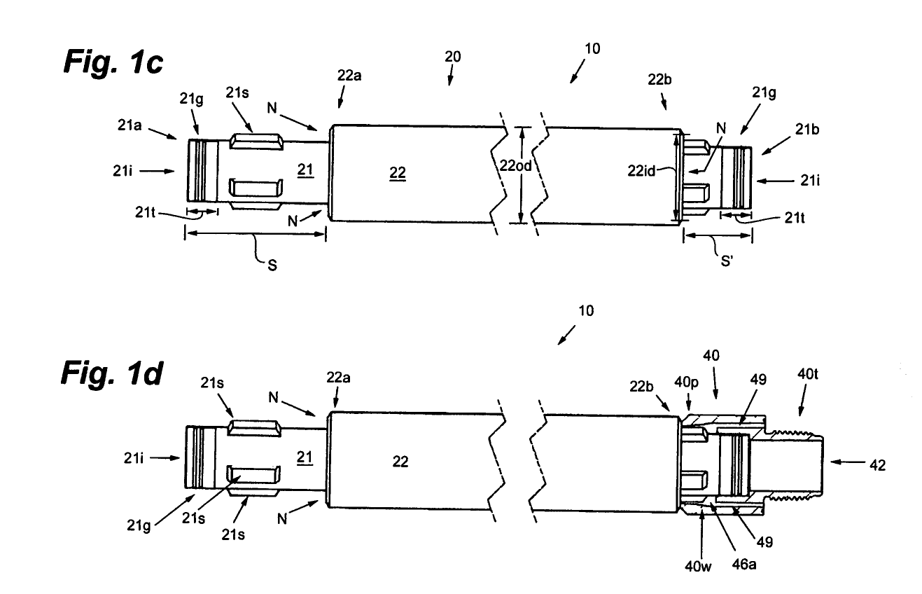

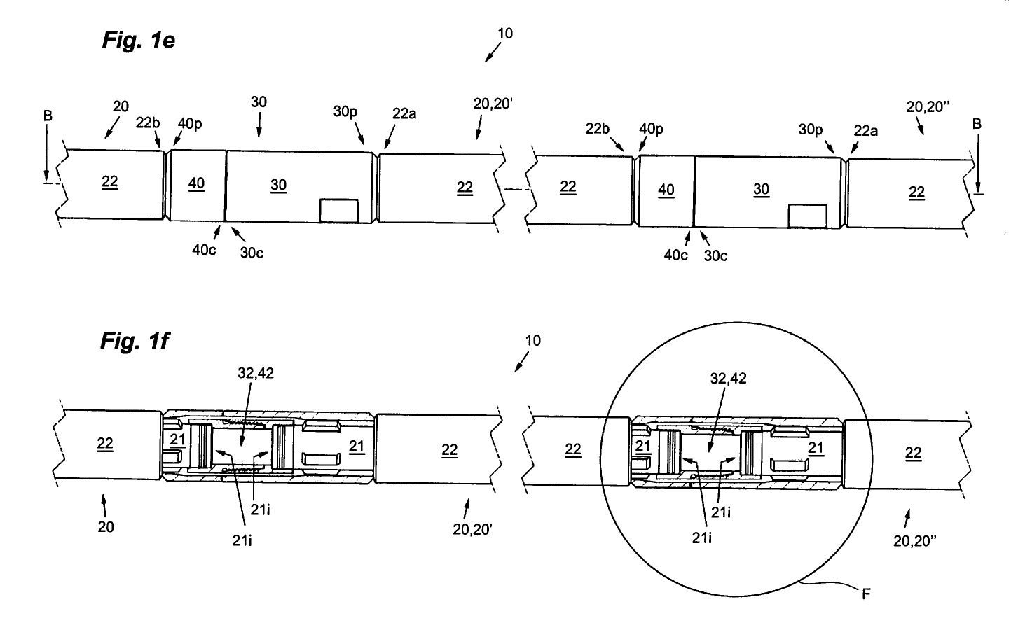

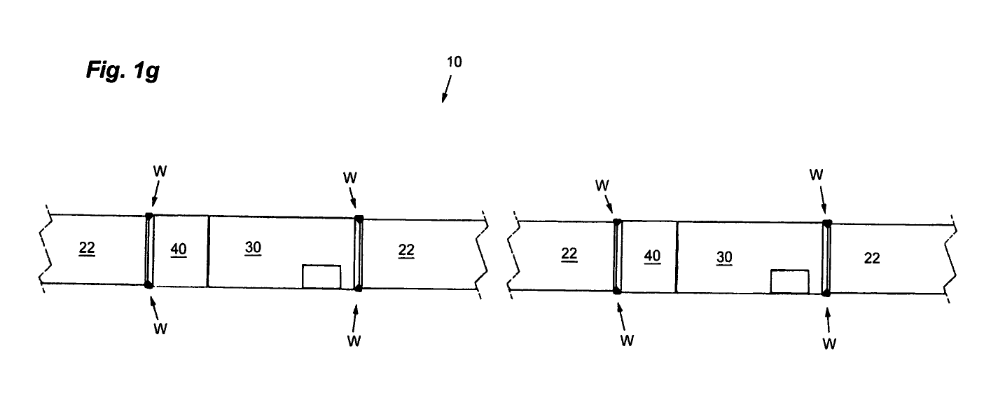

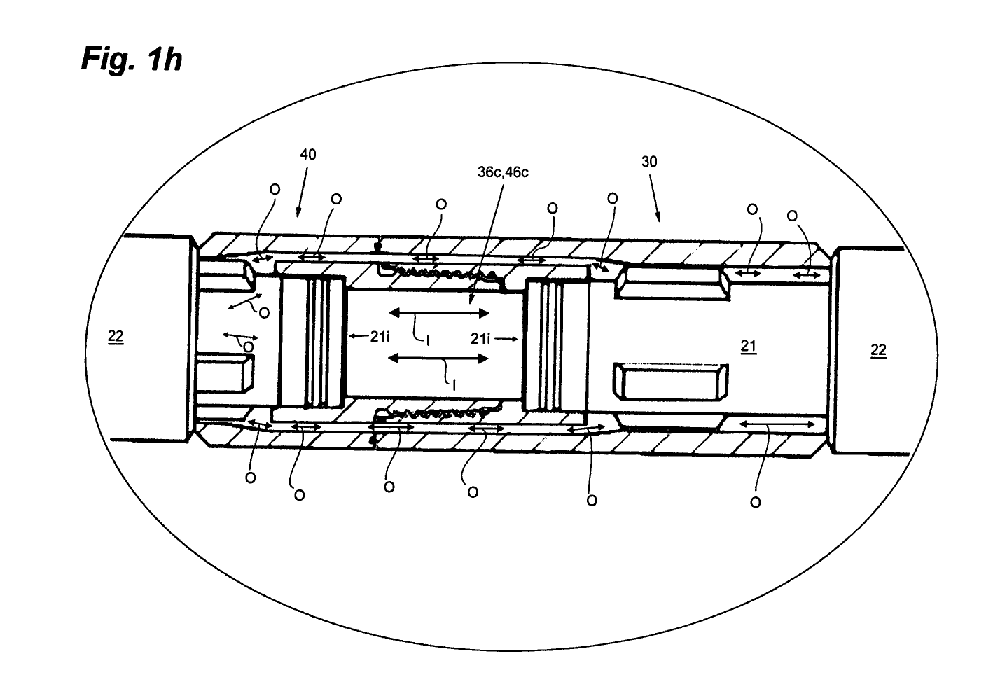

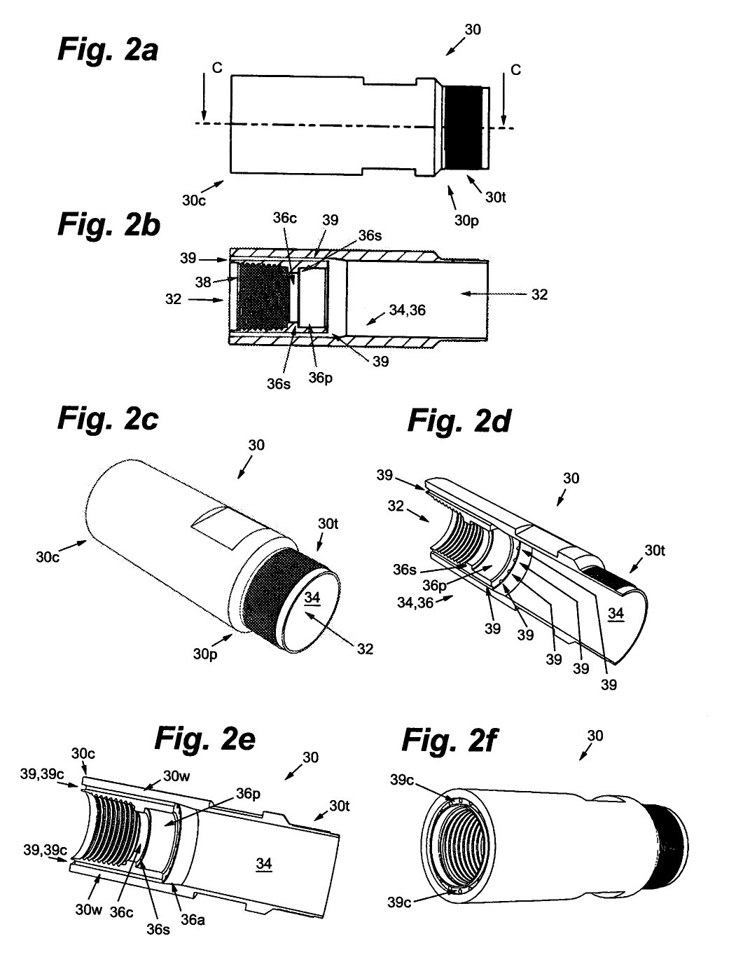

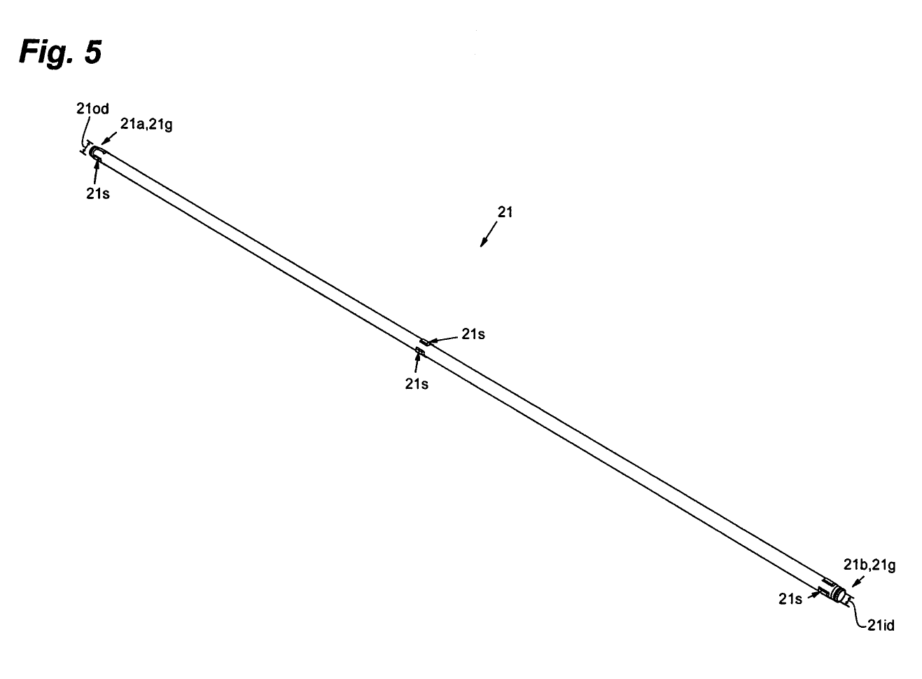

Referring now to FIGS. 1a-5, the reverse circulation drilling system 10 comprises a concentric dual wall drill pipe 20, with inner pipe 21 positionable or mountable within outer pipe 22 and thereby defining an annulus N therebetween for communication of air and/or drilling fluid (which can, collectively, be referred to as fluid) from surface to a downhole location and further having central inside passage 211 for communication of exhausted fluid and cuttings from a downhole location back to surface; for example, see FIG. 1c. As such, inner pipe 21 will have an outside diameter 21od that is smaller than the inside diameter 22id of outer pipe 22, so as to create said annulus N. As is conventional in reverse circulation drilling systems, annulus N is separate from, and has no fluid communication with said inner pipe's inside passage 21i.

Preferably, the cross-sectional area of annulus N and, accordingly, the dimensions of both inner and outer pipes 21, 22, generally matches the cross-sectional area and dimensions of conventional reverse circulation drill pipe or, if not, is at least of sufficient cross-sectional area to allow for conventional reverse circulation drilling operations, including allowing a sufficient quantity and flow of fluid to be pumped therethrough to a downhole location. More preferably, the cross-sectional area of inside passage 21i generally matches the cross-sectional area and dimensions of conventional inside passages in reverse circulation drill pipe or, if not, is at least of sufficient cross-sectional area to allow for conventional reverse circulation drilling operations, including allowing a sufficient quantity and flow of exhausted fluid and cuttings to be pumped therethrough back up to surface.

Even more preferably, inner pipe 21 further comprises a plurality of spacing members 21s placed along its outside diameter 22od to maintain proper concentric alignment of inner pipe 21 while within outer pipe 22 and thereby provide a proper annulus N along the entire length of the dual wall drill pipe 20. Yet even more preferably, spacing members 21s further comprise rubber or flexible contact patches (not shown) at the contact points between spacing members 21s and inside surface of outer pipe 22, so as to provide shock absorption to the inside pipe 21 and the system 10. Still even more preferably, outer pipe 22 is a conventional drill pipe section, but without the traditional tool joints.

In the preferred embodiment of the present invention, and unlike conventional reverse circulation drilling systems, inner pipe 21 is longer than outer pipe 22, so that, when inner pipe 21 is placed within outer pipe 22 in a concentric arrangement, end portions 21a, 21b of inner pipe 21 project out from outer pipe 22 a predefined distance S, S′ respectively at either end 22a, 22b of outer pipe 22 (see FIG. 1c). Preferably, and so as to provide sufficient working area and working surface to easily and efficiently make a high pressure sealable connection (as further described below), predefined distances S, S′ are at least as long as the outside diameter 21od of inner pipe. More preferable, and so as not to become too cumbersome, predefined distances S, S′ are not longer than five times the outside diameter 21od of inner pipe. A preferred range for predefined distances S, S′ is between 3 to 8 inches. However, it will be understood by those skilled in the art that shorter or longer predefined distances will also work. Even more preferably, end portions 21a, 21b of inner pipe 21 each feature a tip region 21t that is devoid of any spacing members 21s. Yet even more preferably, tip region 21t is provided with pressure sealing member grooves 21g capable of housing sealing members, such as o-rings or the like. Advantageously, sealing members, such as o-rings, at each end 21a, 21b of inner pipe 21, add further shock absorption to the system 10.

The reverse circulation drilling system 10 further comprises first and second drill subs 30, 40, which are sealably, removably securable to either end portions 22a, 22b of outer pipe 22. Drill subs 30, 40 are each substantially tubular members, each have a pipe end 30p, 40p and a connection end 30c, 40c and each having a main internal through passage 32, 42 therethrough from pipe end 30p, 40p to connection end 30c, 40c. Drill subs 30, 40 each further comprise at least one annular passage 39, 49. Preferably, first and second drill subs 30, 40 have a plurality of annular passages 39, 49, wherein the total cross-sectional area of said plurality of annular passages generally matches the cross-sectional area of the annulus in a conventional reverse circulation drill pipe or, if not, is at least of sufficient cross-sectional area to allow for conventional reverse circulation drilling operations, including allowing a sufficient quantity and flow of fluid to be pumped therethrough to a downhole location to allow drilling operations.

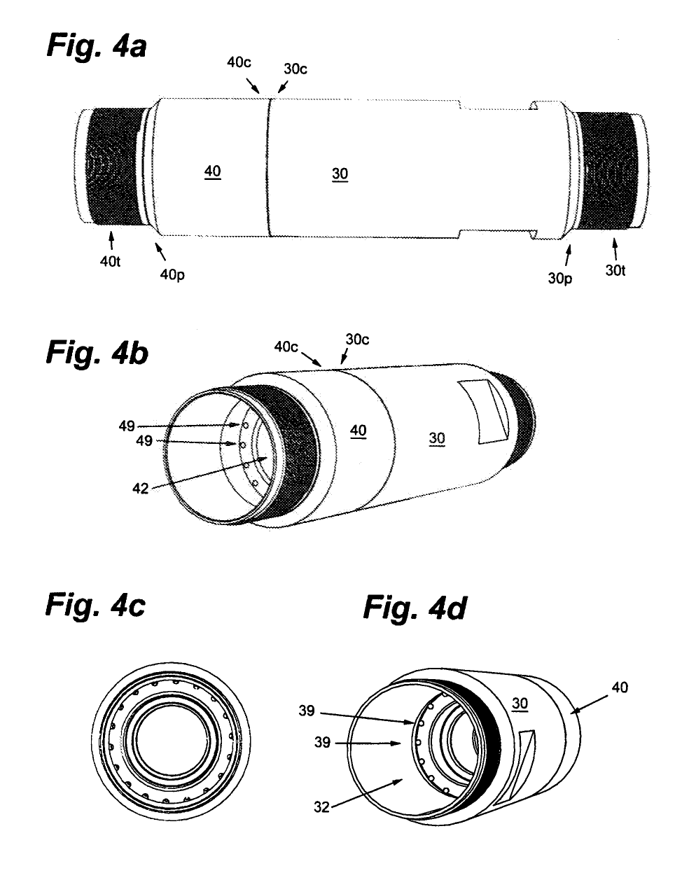

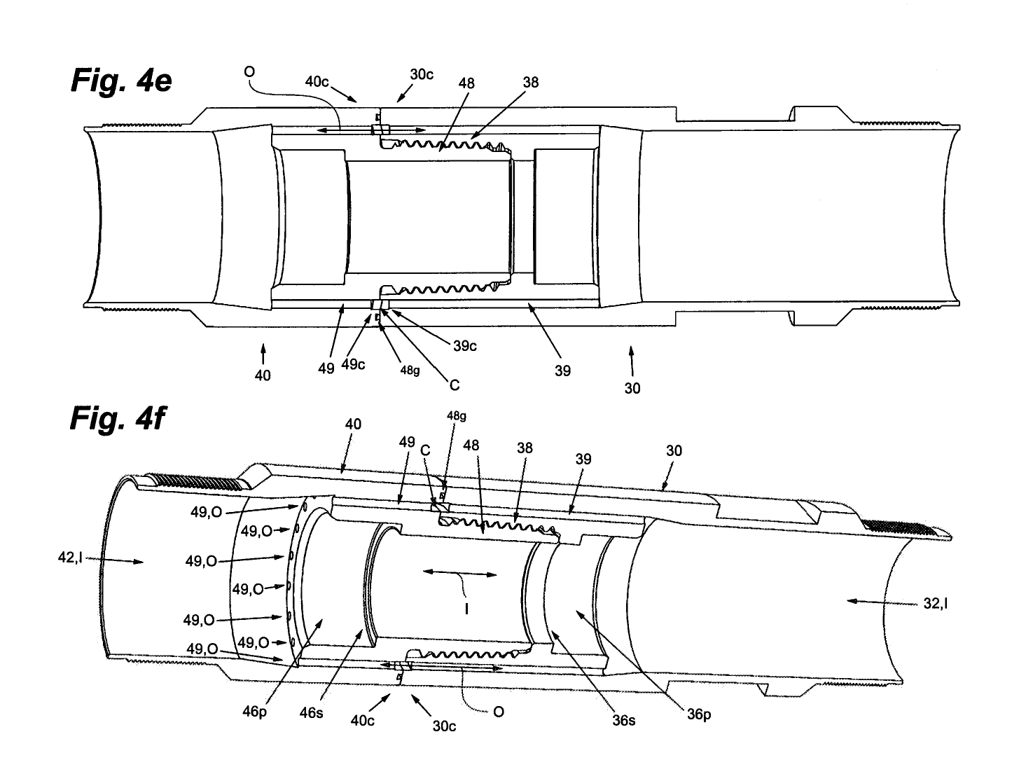

Connection ends 30c, 40c are suitable to sealably connect one drill sub to another, adjacent drill sub of an adjacent outer pipe. In the preferred embodiment, the first drill sub 30 can be referred to as a box-end drill sub, wherein connection end 30c comprises an internally threaded connection 38, while the second drill sub 40 can be referred to as a pin-end drill sub, wherein connection end 40c comprises an externally threaded connection 48. Preferably, internally threaded connection 38 of box-end sub 30 mates with, and sealably connects to, externally threaded connection 48 of pin-end sub 40 (see FIGS. 4a-4f). More preferably, connection ends 30c, 40c and threaded connections 38, 48 are also suitable to sealably connect to drill subs 30, 40 to conventional downhole equipment such as bottomhole assemblies and drill bits. Advantageously, a drill sub 30, 40 located at the downhole end of the system 10 can easily connect to such conventional downhole equipment without the need for intermediary adapters or intermediary bit subs.

Preferably, first and second drill subs 30, 40 are threadably connected to end portions 22a, 22b of outer pipe 22 at their respective pipe ends 30p, 40p. More preferably, first and second drill subs 30, 40 are threadably connected via internal threadable sections (not shown) at end portions 22a, 22b (on outer pipe 22) and mating external threadable section 30t, 40t (on the respective pipe ends 30p, 40p). In an alternate embodiment (not shown), first and second drill subs 30, 40 are threadably connected via external threadable sections at end portions 22a, 22b (on outer pipe) with mating internal threadable section on the respective pipe ends 30p, 40p.

Preferably, drill subs 30, 40 are each provided with an outer wall portion 30w, 40w of thickened conduit wall material that is substantially equal the outside diameter 22od of the outer pipe 22 so that, once drill subs 30, 40 are threadably connected to outer pipe 22, the outside diameter of the drill sub 30, 40 is substantially the same as, or flush with, the outside diameter 22od of the outer pipe 22. More preferably, end portions 22a, 22b, as well as outer wall portions 30w, 40w on each of first and second drill subs 30, 40 respectively, are provided with facing chamfered or beveled edges (see FIG. 1a). Advantageously, such facing chamfered or beveled edges allow for a groove weld W to make a permanent edge-to-edge joint between each of first and second drill subs 30, 40 and their respective end portions 22a, 22b of outer pipe 22 once drill subs 30, 40 are threadably connected to outer pipe 20 (see FIG. 1g). Advantageously, threadable connection between each of first and second drill subs 30, 40 and the respective end portions 22a, 22b of outer pipe 22 is further secured and strengthened by groove weld W, allowing each of first and second drill subs 30, 40 with their thickened outer wall portions 30w, 40w to function like a conventional tool joint and impart rotational forces and torque through to outer pipe 22. Depending on the particular drilling application where the system 10 is to be utilized, groove weld W may be flush with the outer diameter 22od of the outer pipe 22 or it may be a quicker weld where less attention is paid to keeping said weld W flush with said outer diameter 22od.

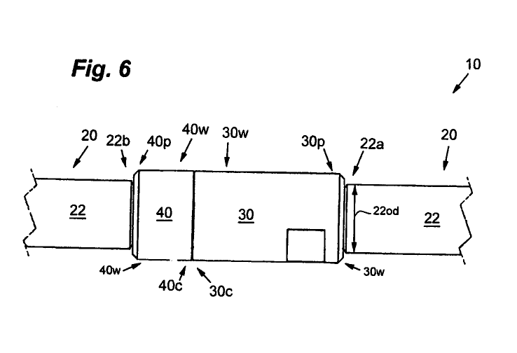

In another embodiment, shown in FIG. 6, outer wall portions 30w, 40w of first and second drill subs 30, 40 comprise a thickened conduit wall that is greater than the outside diameter 22od of the outer pipe 22. This large-diameter section 30w, 40w provides an area where pipe tongs can be safely used to grip the pipe 20 and where the relatively small cuts caused by the pipe tongs do not significantly impair the strength or life of the joint of the drill subs 30, 40.

Through passages 32, 42, in each of first and second drill subs 30, 40, define an internal surface 34, 44 with a profile 36, 46 thereon. Going from the pipe end 30p, 40p toward the connection end 30c, 40c, the profiles 36, 46 each provide an annulus region 36a, 46a, an inner pipe passage 36p, 46p, an inner pipe stopping shoulder 36s, 46s and a central passage 36c, 46c. Profile 36 may also provide an internally threaded region 38 at connection end 30c (past central passage 36c) to mate with an appropriate externally threaded region 48 at a connection end 40c of another adjacent drill sub 40 (see FIGS. 4e-4f, for example).

In the preferred embodiment of FIGS. 1a-5, and so as to facilitate connection of adjacent sections of concentric dual wall drill pipes 20, 20′, 20″ (see FIGS. 1e, 1f), first drill sub 30 is provided with an internally threaded region 38 at connection end 30c, while second drill sub 40 is provided with an appropriate externally threaded region 48 at connection end 40c. First drill sub 30 may be sealable, securably connected (to second drill sub 40) via internally threaded region 38 being threaded to externally threaded region 48 of a second drill sub 40.

Preferably, annular passages 39, 49 of adjacently connected first and second drill subs 30, 40 co-axially align with each other so as to provide fluid communication (for annular outer flow O of fluids) between adjacent sections of concentric dual wall drill pipes 20 (e.g. see FIGS. 1e, 1f, between drill pipes 20 and 20′ and between drill pipes 20′ and 20″). More preferably, annular passages 39, 49 terminate into an annular passage circumferential groove 39c, 49c provided at connection end 30c, 40c which, when first and second drill subs 30, 40 as adjacently connected, define a connection cavity C (see FIGS. 4e, 4f). Advantageously, connection cavity C further facilitates fluid communication (for annular outer flow O of fluids) between adjacent sections of concentric dual wall drill pipes 20, even when annular passages 39, 49 happen not to co-axially align with each other.

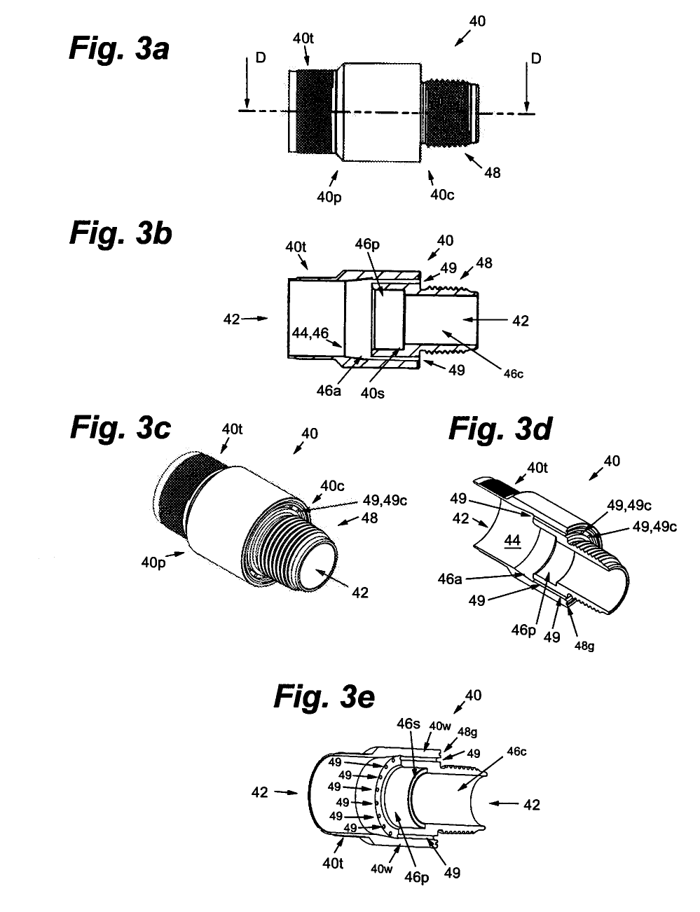

More preferably, sealing member grooves 48g are provided at one or both of the connection ends 30c, 40c for the first and second drill sub 30, 40, so as to house a sealing member (such as an o-ring) and further facilitate sealable, threadable connection of two drill subs 30, 40 to each other at their connection ends 30c, 40c. In the preferred embodiment of FIGS. 1a-5, second drill sub 40 is provided with sealing member groove 48g at its connection end 40c (see FIGS. 3d-3e and 4e-4f).

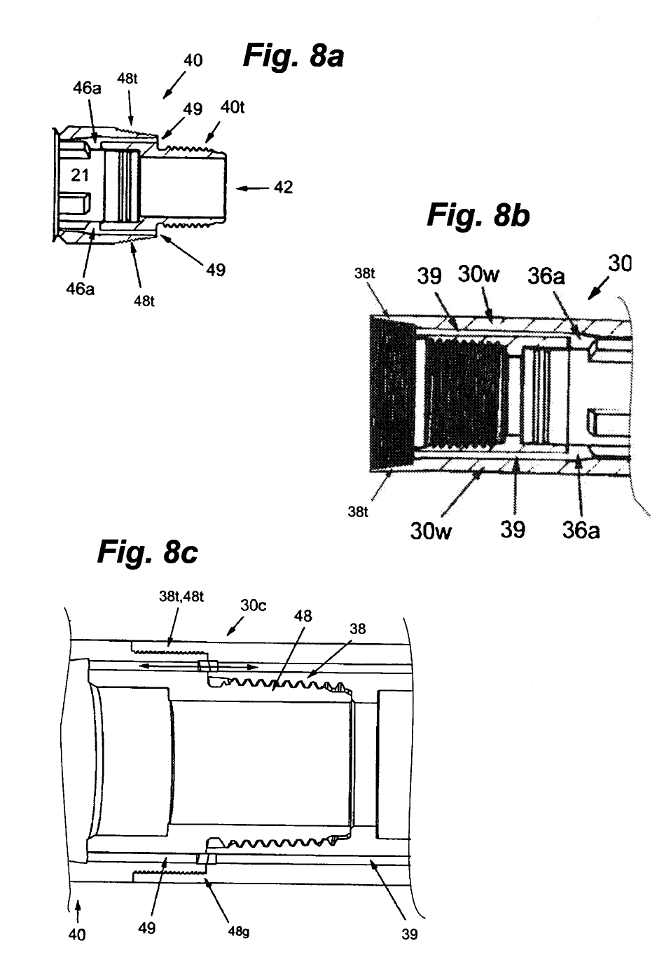

In another embodiment, shown in FIGS. 8a-8c, first drill sub 30 is provided with a second internally threaded region 38t at connection end 30c, while second drill sub 40 is provided with a second appropriately matching externally threaded region 48t at connection end 40c. These second threaded regions 38t, 48t, further enhance and facilitated connection of first drill sub 30 to second drill sub 40 (see FIG. 8c). Advantageously, second threaded regions 38t, 48t also reduce or eliminate the need for sealing member grooves 48g and sealing members.

Annulus regions 36a, 46a have an inside diameter and profile of sufficient size and dimensions to accommodate a section of inner pipe 21 including any spacing members 21s. Annulus regions 36a, 46a are in fluid communication with the annular passage(s) 39, 49 and also with annulus N once drill subs 30, 40 are connected to outer pipe 22 and over inner pipe 21. In contrast, inner pipe passages 36p, 46p are of a smaller inside diameter than the annulus regions 36a, 46a and are just of sufficient size and dimensions to accommodate at least tip region 21t of inner pipe 21, and any sealing members that may be present in any pressure sealing member grooves 21g, so as to sealably engage tip region 21t and to also then isolate any fluids in the annulus N, annulus regions 36a, 46a and annular passages 39, 49 from the inside passage 21i and central passages 36c, 46c.

Advantageously, during drilling operations, annulus regions 36a, 46a and annular passage(s) 39, 49 of the system 10 divert and direct any fluids that may flow as an outer flow O in the annulus N from one dual walled pipe 20 to the annulus N of an adjacent dual walled pipe 20′ via connected drill subs 30, 40 (see FIG. 1h). More advantageously, during drilling operations, interior profiles 36, 46 of connected adjacent drill subs 30, 40 provide a sealing engagement between an inner pipe 21 of one dual walled pipe 20 to the inner pipe 20 of an adjacent dual walled pipe 20, so that any fluids that may flow freely as an inner flow I between adjacent inner pipes 21 without any cross contamination of inner flow I with outer flow O (see FIG. 1h), i.e. no fluid communication between outer flow O and inner flow I.

As can be seen in the figures, pipe stopping shoulders 36s, 46s are of a smaller inside diameter than the inner pipe passages 36p, 46p. They are sufficiently smaller so as to prevent any further passage of the inner pipe 21 into central passage 36c, 46c and towards the connection end 30c, 40c. Pipe stopping shoulder 36s, 46s, however, still has a sufficiently large through bore to allow sufficient fluid communication between the inner pipe's inside passage 211 and the remainder of the main through passage 32, 42, including central passages 36c, 46c that extends towards the connection end 30c, 40c.

As is also evident from the figures, central passage 36c, 46c are of generally smaller diameter and dimensions than inner pipe passage 36p, 46p. Preferably, central passages 36c, 46c are of substantially the same diameter, dimensions and cross-sectional area as the inner pipe's inside passage 21i. Advantageously, when inner pipe 21 is positioned adjacent pipe stopping shoulder 36s, 46, and the system 10 is fully assembled, the inner surface of central passage 36c, 46c are substantially flush with the inner surface of inside passage 211 (see, for example, FIG. 1h). More advantageously, these generally flush inside surfaces result in less opportunity for cuttings or other contaminants to wear out system components or shoulders that may project within similar inner passages of traditional reverse circulation drilling.

More preferably, annulus region 36a, 46a and inner pipe passage 36p, 46p of first and second drill subs 30, 40, are of such dimensions so as to substantially capture or encase the end portions 21a, 21b of inner pipe 21 which project out from outer pipe 22, (i.e. distance S, S′, at either end 22a, 22b of outer pipe 22), when drill subs 30, 40 are threadably connected to outer pipe 22. Advantageously, first and second drill subs 30, 40 capture inner pipe 21 in concentric arrangement within outer pipe 22 (on a pipe-by-pipe basis), allowing for pre-assembly of a dual wall section of pipe 20 (such as in a manufacturing facility) that will only require field assembly of one section of dual walled pipe 20 to an adjacent section of dual walled pipe 20, such as by simple threadable means.

Advantageously, there is no longer any need to assemble inner pipe to inner pipe and outer pipe to outer pipe at a rig site, as is the case with conventional reverse circulation drilling systems. More advantageously, inner pipe 21 is completely contained within the within the dual wall drill pipe 20 and tightened into proper place when first and second drill subs 30, 40 are threaded onto the outer pipe 22.

Pre-assembly of the dual walled pipe 22 in a shop or manufacturing facility, such as by: (i) placing inner pipe 21 within outer pipe 22, (ii) adjusting inner pipe so that ends 21a, 21b project the predetermined distance S, S′, (iii) sealably connecting first and second drill subs 30, 40 over said ends 21a, 21b and, if necessary (iv) welding groove welds W, significantly reduces on-site assembly workload. As such, the system 10 of the present invention only requires simple assembly of one dual walled drill pipe sections 20 to and adjacent dual walled section 20, thereby significantly increasing drilling productivity as compared to conventional reverse circulation drilling systems.

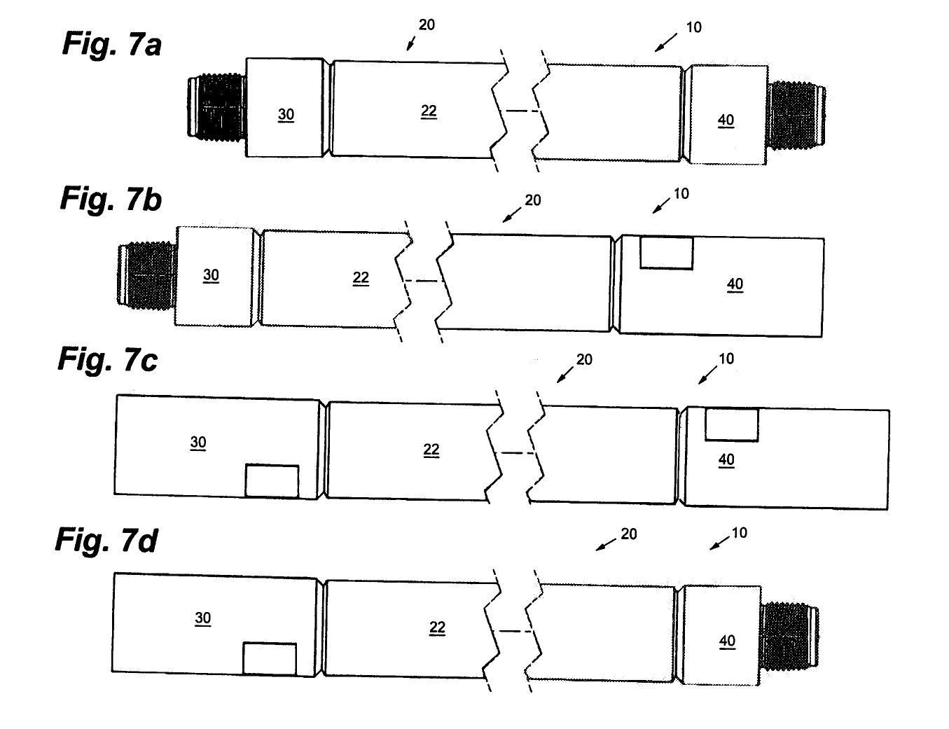

Optionally, first and second drill subs 30, 40 on either end of outer pipe 22a, 22b, may be arranged in various configurations as may be desired, including as pin-pin, pin-box, box-box, or box-pin configurations, see FIGS. 7a-7d. Advantageously, a reverse circulation drill string can be easily and efficiently assembled at rig site by choosing the desired configuration of first and second drill subs 30, 40 on a particular dual walled section of pipe 20 and then simply threading such section of dual walled pipe 20 to an adjacent dual walled pipe 20. This can all be done without having to worry about placing and threading an inner pipe to an inner pipe and an outer pipe to an outer pipe. More advantageously, by pre-assembly of inner pipe 21 sealably within outer pipe 22, i.e. by using drill subs 30, 40 in a controlled environment such as a manufacturing shop, there is much less chance of drill cuttings and other contaminants being caught in sealing members (e.g. orings) of the various inner pipes as may be the case with conventional reverse circulation drilling systems assembled in the field at the rig site.

Preferred Dimensions of the Preferred Embodiment

The following are preferred dimensions for the preferred embodiment of FIGS. 1a-5. In said preferred embodiment, the outer pipe 22 ranges from 5 feet to 30 feet in length and the inner pipe 21 will ideally be 6 to 16 inches longer. Typical outside diameters of the outer pipe 22 ranges from 2.875″ to 14″. The wall thickness of the outer pipe 22 varies from 0.250″ to 0.50″, with the most common thickness for a mid range diameter outer pipe 22 being a 0.437″ wall. The outside diameter of the inner pipe 21 preferably maintains a minimum clearance of 0.250″ between it and the inside diameter of the outer pipe 22 per side.

As the size of the outer pipe 22 increases the minimum clearance of the inner pipe 22 preferably also increases. For example, in an embodiment where the outer pipe 22 has an outside diameter of 14 inches, the clearance between the outside diameter of the inner pipe 21 and the inside diameter of the outer pipe 22 is preferably a minimum of ⅝″ per side. The wall thickness of the inner pipe 21 preferably increases at the same rate as that of the outer pipe 22 (as pipe diameters increase) and ranges from 0.250″ to 0.50″, with the most common thickness for a mid range diameter inner pipe 21 being a 0.375″ wall.

The number of spacing members 21s preferably increases with the length of the inner pipe 21 and the spacing members 21s preferably come in multiples of 3 or 4. In an embodiment where there is a clearance of 0.25″ between the inner pipe 21 and outer pipe 22, the dimensions of a preferred embodiment of a spacing member 21s is 1.5″ long by 0.25″ wide by 0.25″ tall.

The preferred cross sectional area of the inner passage 21i is approximately 4.5 times that of the area of the annulus N. For example, a reverse circulation system 10 where the outside diameter of the outer pipe 22 is 4.5 inches, the annulus N cross-sectional area is preferably 0.79 sq inch and the inner passage 211 cross-sectional area is approximately 3.46 sq inch, based on 0.4375″ wall outer pipe 22 and a 2.75 outside diameter inner pipe 21 with a 0.325″ wall.

In the claims, the word “comprising” is used in its inclusive sense and does not exclude other elements being present. The indefinite article “a” before a claim feature does not exclude more than one of the features being present. Those of ordinary skill in the art will appreciate that various modifications to the invention as described herein will be possible without falling outside the scope of the invention.

The embodiments of the invention in which an exclusive property or privilege is being claimed are defined as follows:

1. A reverse circulation drilling apparatus comprising:
a concentric dual wall drill pipe, having a first end, a second end, an outer pipe and an inner pipe positionable within the outer pipe and defining an annulus therebetween, said inner pipe defining a central inside passage, wherein said inside passage is not in fluid communication with the annulus;
a first drill sub attached to the first end and having an internal through passage and at least one annular passage, wherein said internal through passage is not in fluid communication with said annular passage;
a second drill sub attached to the second end and having an internal through passage and at least one annular passage, wherein said internal through passage is not in fluid communication with said annular passage;
wherein the annular passages of the first and second drill subs are in fluid communication with said annulus; and
wherein the internal through passages of the first and second drill subs are in fluid communication with said central inside passage.

2. The reverse circulation drilling apparatus of claim 1 wherein inner pipe further comprises a plurality of spacing members along its outside diameter.

3. The reverse circulation drilling apparatus of claim 2 wherein the spacing members further comprise flexible contact patches.

4. The reverse circulation drilling apparatus of claim 1 wherein the first drill sub is a pin-end drill sub and the second drill sub is a box-end drill sub.

5. The reverse circulation drilling apparatus of claim 1 wherein the first drill sub and the second drill sub are both pin-end drill subs.

6. The reverse circulation drilling apparatus of claim 1 wherein the first drill sub and the second drill sub are both box-end drill subs.

7. A reverse circulation drilling apparatus comprising:
a concentric dual wall drill pipe, having a first threaded end, a second threaded end, an outer pipe and an inner pipe captured in a concentric arrangement within the outer pipe and defining an annulus therebetween, said inner pipe defining an inside passage, wherein said inside passage is not in fluid communication with the annulus;
a first means for directing an outer flow of fluid through said annulus;
a second means for directing an inner flow of fluid through said inside passage;
wherein said first means and said second means prevent fluid communication between the outer flow and the inner flow; and
wherein the first threaded end and the second threaded end are each suitable to connect the reverse circulation drilling apparatus to another reverse circulation drilling apparatus.

8. The reverse circulation drilling apparatus of claim 7, wherein the first means comprises:
a first drill sub attached to the first end and having at least one annular passage;
a second drill sub attached to the second end and having at least one annular passage; and
wherein the annular passages of the first and second drill subs are in fluid communication with said annulus.

9. The reverse circulation drilling apparatus of claim 8, wherein the second means comprises:
an internal through passage in each of the first and second drill subs;
wherein said internal through passages are not in fluid communication with said annular passages; and
wherein the internal through passages of the first and second drill subs are in fluid communication with said inside passage.

10. A reverse circulation drilling system comprising a plurality of the reverse circulation drilling apparatuses of claim 1 connected together at their respective first and second ends.

11. A reverse circulation drilling system comprising a plurality of the reverse circulation drilling apparatuses of claim 7 threadably connected together at their respective first and second threaded ends.

12. A method of assembling a reverse circulation drilling apparatus having an inner pipe, a slightly shorter outer pipe and first and second drill subs, the method comprising the steps of:
placing the inner pipe within outer pipe;
adjusting the inner pipe so that its ends project a predetermined distance out of the ends of the outer pipe;
sealably connecting first and second drill subs to the outer pipe and over said inner pipe ends; and
wherein the inner pipe is captured in a concentric arrangement within the outer pipe and defines an annulus therebetween.

13. A drill sub for use in reverse circulation drilling operations and having a pipe end and a connection end, the drill sub comprising:
an internal through passage through the drill sub spanning from pipe end to connection end; and
at least one annular passage;
wherein said internal through passage is not in fluid communication with said annular passage.

14. The drill sub of claim 13 comprising a plurality of annular passages wherein the total cross-sectional area of said plurality of annular passages is of sufficient cross-sectional area to allow a sufficient flow of fluid to be pumped therethrough to allow for reverse circulation drilling operations.

15. The drill sub of claim 13 wherein connection end is suitable to sealably connect the drill sub to another drill sub.

16. The drill sub of claim 13 wherein the internal through passage defines an internal surface with a profile thereon, said profile further comprising:
an annulus region;
an inner pipe passage;
an inner pipe stopping shoulder; and
a central passage.
